(19) United States
(12) Patent Application Publication
(10) Pub. No.: US 2011/0180516 A1
(43) Pub. Date: Jul. 28, 2011

(54) POSITION DETECTION DEVICE AND A POSITION DETECTION METHOD FOR A WORKPIECE TO BE WELDED

(75) Inventors: Hiromitsu TAKAHASHI, Minamitsuru-gun (JP); Toshimichi Aoki, Minamitsuru-gun (JP); Masanobu Hatada, Minamitsuru-gun (JP); Akinori Nishimura, Minamitsuru-gun (JP)

(73) Assignee: FANUC LTD, Minamitsuru-gun (JP)

(21) Appl. No.: 12/978,812

(22) Filed: Dec. 27, 2010

(30) Foreign Application Priority Data
Jan. 28, 2010 (JP) 2010-017202

(51) Int. Cl. B23K 11/11

(52) U.S. Cl. 219/86.41

(57) ABSTRACT

A position detection device for a workpiece to be welded including a spot welding gun having a pair of electrodes adapted to be disposed opposite each other across the workpiece; a robot for holding either one of the spot welding gun and the workpiece in a manner movable relate to each other; a servo motor for allowing the pair of electrodes to approach the workpiece and separate from the workpiece; a physical quantity detection section for detecting a physical quantity correlative to a torque of the servo motor when the servo motor allows one of the pair of electrodes to approach a surface of the workpiece so that the one of the pair of electrodes abuts against the surface of the workpiece; a position detection section for detecting positions of the pair of electrodes; a storage section for storing the physical quantity detected by the physical quantity detection section and a value detected by the position detection section; and a computation section for calculating a contact start time at which the one of the pair of electrodes comes into contact with the surface of the workpiece based on time-series data of the physical quantity stored in the storage section, and computing a position of the workpiece at the contact start time based on the value detected by the position detection section stored in the storage section.

### BACKGROUND OF THE INVENTION

1. Field of the Invention

The present invention relates to a position detection device and a position detection method for a workpiece to be welded for detecting a position of the workpiece to be spot welded.

2. Description of the Related Art

When a workpiece is spot welded by automatically by using a robot, if a workpiece position (spot welding point position) recorded in a working program deviates from an actual workpiece position, problems such that an overload is applied to the workpiece and welding current does not properly flow may occur, which results in degradation of welding quality. Consequently, in the conventional art, the workpiece position is detected in advance before spot-welding and the spot welding point position is corrected according to the detected workpiece position.

In the system described in Japanese patent Publication No. 4233584 (JP4233584B), a workpiece is disposed between a movable electrode and a counter electrode of a spot welding gun and the movable electrode is driven by a servo motor to approach a workpiece surface. Then, when a motor current exceeds a predetermined value, it is determined that the movable electrode makes contact with the workpiece surface and a disturbance torque is generated in the servo motor and, based on the movable electrode position at that time, the workpiece position is detected.

In the system described in JP4233584B, on the assumption that the torque of the servo motor varies in a stepwise manner when the movable electrode makes contact with the workpiece surface, the workpiece position is detected. However, the torque of the actual servo motor tends to increase gradually after the movable electrode makes contact with the workpiece surface. Thus, at the moment when the motor current exceeds the predetermined value, the movable electrode has already pushed the workpiece surface sufficiently and advanced further than the contact position. Consequently, if it is judged that the movable electrode makes contact with the workpiece surface when the motor current exceeds the predetermined value, the workpiece position cannot be accurately detected.

### SUMMARY OF THE INVENTION

According to an aspect of the present invention, a position detection device for a workpiece to be welded includes a spot welding gun having a pair of electrodes adapted to be disposed opposite each other across the workpiece; a robot for holding either one of the spot welding gun and the workpiece in a manner movable relate to each other; a servo motor for allowing the pair of electrodes to approach the workpiece and separate from the workpiece; a physical quantity detection section for detecting a physical quantity correlative to a torque of the servo motor when the servo motor allows one of the pair of electrodes to approach a surface of the workpiece so that the one of the pair of electrodes abuts against the surface of the workpiece; a position detection section for detecting positions of the pair of electrodes; a storage section for storing the physical quantity detected by the physical quantity detection section and a value detected by the position detection section; and a computation section for calculating a contact start time at which one of the pair of electrodes comes into contact with the surface of the workpiece based on time-series data of the physical quantity stored in the storage section, and computing the position of the workpiece at the contact start time based on the value detected by the position detection section stored in the storage section.

Further, according to another aspect of the present invention, a position detection method for a workpiece to be welded for detecting a surface position of the workpiece includes the steps of holding, by a robot, either one of a spot welding gun and the workpiece in a manner movable relate to each other, the spot welding gun having a pair of electrodes adapted to be disposed opposite each other across the workpiece; allowing, by a servo motor, one of the pair of electrodes to approach a surface of the workpiece so that the one of the pair of electrodes abuts against the surface of the workpiece; judging a contact start time at which the one of the pair of electrodes comes into contact with the surface of the workpiece, based on a physical quantity correlative to a torque of the servo motor when the one of the pair of electrodes approaches the surface of the workpiece; and computing a position of the workpiece based on positions of the pair of electrodes at the contact start time.

### BRIEF DESCRIPTION OF THE DRAWINGS

The object, features and advantages of the present invention will become more apparent from the following description of embodiments taken in conjunction with the accompanying drawings, in which:

FIG. 1 is a diagram schematically illustrating an overall configuration of a spot welding system having a position detection device for a workpiece to be welded according to an embodiment of the present invention;

FIG. 2 is a diagram illustrating operations of a movable electrode and a counter electrode due to execution of a working program;

FIG. 3 is a flowchart illustrating an example of a process carried out in a robot controller and a welding gun controller of FIG. 1;

FIG. 4A is a diagram illustrating operations of the movable electrode and the counter electrode in the workpiece position detection process of FIG. 3;

FIG. 4B is a diagram illustrating operations of the movable electrode and the counter electrode in a workpiece position detection process of FIG. 3;

FIG. 4C is a diagram illustrating operations of the movable electrode and the counter electrode in the workpiece position detection process of FIG. 3;

FIG. 4D is a diagram illustrating operations of the movable electrode and the counter electrode in the workpiece position detection process of FIG. 3;

FIG. 5 is a diagram illustrating an example of variation over time of motor torque and motor velocity of a servo motor for driving the movable electrode in the workpiece position detection process of FIG. 3;

FIG. 6A is a diagram describing a process according to a pushing determination of the movable electrode by using specific time-series variation of the motor torque;

FIG. 6B is a diagram illustrating a variant of FIG. 6A;

FIG. 7A is a diagram describing a process according to a determination of a contact start time of the movable electrode by using the specific time-series variation of the motor torque;

FIG. 7B is a diagram illustrating a variant of FIG. 7A;

FIG. 8 is a diagram illustrating a variant of FIG. 1; and

FIG. 9 is a diagram illustrating another variant of FIG. 1.

### DETAILED DESCRIPTION

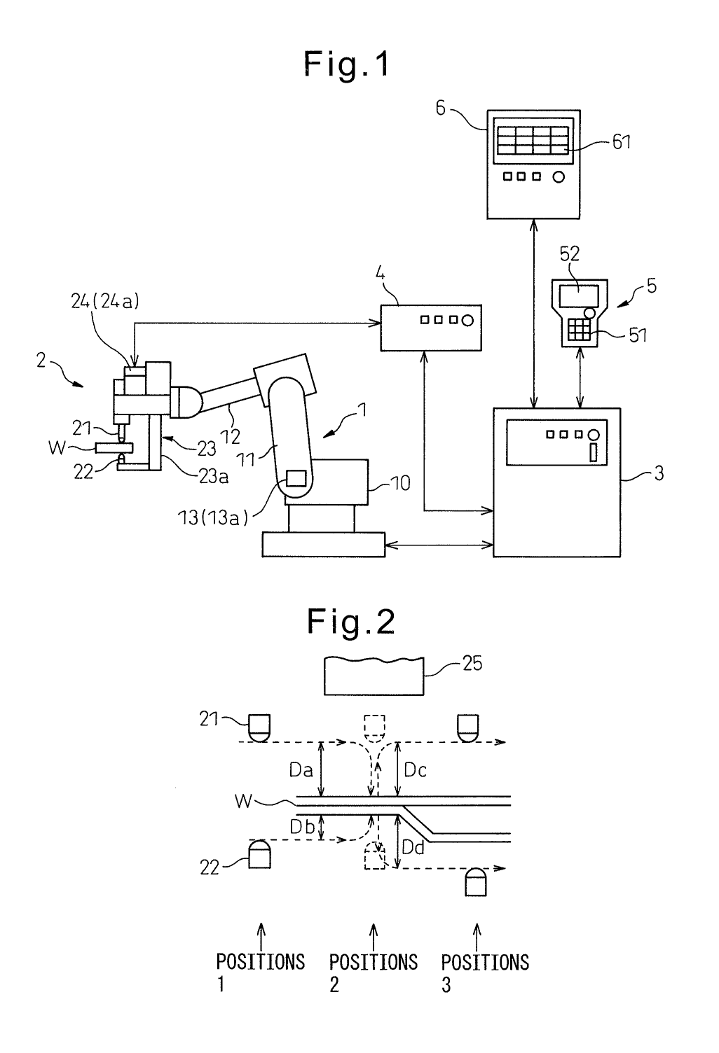

Hereinafter, referring to FIGS. 1 to 9, a position detection device for a workpiece to be welded according to embodiments of the present invention will be described. FIG. 1 is a diagram schematically illustrating an overall configuration of a spot welding system having a position detection device for a workpiece to be welded according to an embodiment of the present invention. The spot welding system of FIG. 1 comprises an articulated robot 1, a spot welding gun 2, a robot controller 3 for controlling robot 1, and a welding gun controller 4 for controlling spot welding gun 2.

Robot 1 is a common 6-axis vertical articulated robot that has a base 10 secured to a floor; a lower arm 11 rotatably coupled to base 10; an upper arm 12 rotatably coupled to a tip of lower arm 11; and spot welding gun 2 rotatably attached to a tip of upper arm 12. Robot 1 has a plurality of servo motors 13 (only one is illustrated for convenience) for driving the robot. Servo motors 13 are driven by control signals from robot controller 3, so that a position and orientation of spot welding gun 2 is changed.

Spot welding gun 2 is a so-called C-type spot welding gun that has a U-shaped gun arm 23 rotatably coupled to the tip of upper arm 12 and a servo motor 24 for holding a workpiece. Gun arm 23 has a bar-like counter electrode 22 projecting from an end of an L-shaped frame 23a and a bar-like movable electrode 21 projecting oppositely to counter electrode 22. Movable electrode 21 and counter electrode 22 are disposed coaxially to each other. While counter electrode 22 is secured to frame 23a, movable electrode 21 can move coaxially to counter electrode 22 with respect to frame 23a.

Servo motor 24 is driven by control signals from welding gun controller 4, so that movable electrode 21 approaches counter electrode 22 and separates from counter electrode 22. Workpiece W is held between movable electrode 21 and counter electrode 22 in a workpiece thickness direction and workpiece W is spot-welded. Workpiece W is supported by a workpiece supporting device that is not illustrated.

Each servo motor 13 for driving the robot is provided with an encoder 13a that detects an axial rotation angle of servo motor 13. The detected rotation angle is fed back to robot controller 3. The position and orientation of spot welding gun 2 at the tip of the arm are controlled by the feedback control in robot controller 3. As a result, counter electrode 22 integral to frame 23a can be positioned at a taught position in the thickness direction of workpiece W and the position, and orientation of counter electrode 22 can be detected based on the signals from encoders 13a.

Similarly, servo motor 24 for holding the workpiece is provided with an encoder 24a that detects an axial rotation angle of servo motor 24. The detected rotation angle is fed back to welding gun controller 4. Movable electrode 21 can be positioned with respect to counter electrode 22 by the feedback control in welding gun controller 4. A distance between electrodes 21 and 22 varies according to the rotation angle of servo motor 24. In this embodiment, the rotation angle of servo motor 24 when movable electrode 21 is in contact with counter electrode 22 or, in other words, when the distance is zero is defined as a reference value in advance. Consequently, based on the signals from encoder 24a, the rotation angle from the reference value and, i.e., the distance between electrodes 21 and 22 can be detected.

Each of robot controller 3 and welding gun controller 4 includes a processor having a CPU, a ROM, a RAM and other peripheral circuits. Robot controller 3 is connected to welding gun controller 4. Robot controller 3 and welding gun controller 4 communicate with each other to transmit the signals therebetween. Robot controller 3 is further connected to a teaching control panel 5 and a line control panel 6.

In the memory of robot controller 3, operation programs (working programs), teaching data and the like of robot 1 and spot welding gun 2 are stored in rewritable forms. The teaching data includes welding point data that represents the positions and orientations of robot 1 and spot welding gun 2 when workpiece W is spot-welded at a plurality of welding positions. Based on this teaching data, the working programs for automatic operation are created.

During the automatic operation, robot controller 3 operates robot 1 according to the working programs, so as to control the position and orientation of spot welding gun 2 with respect to workpiece W to dispose workpiece W between electrodes 21 and 22. On the other hand, welding gun controller 4 operates movable electrode 21 according to the working programs, so as to control welding pressure applied to workpiece W by electrodes 21 and 22 and control current supplied to electrodes 21 and 22 according to the working programs to carry out the spot welding at a predetermined welding point position.

Teaching control panel 5 has a manipulating section 51 manipulated by an operator and a display section 52 for notifying predetermined information to the operator. From manipulating section 51, teaching commands for the operations of robot 1, commands for editing or executing the working programs and the like are mainly input. Display section 52 indicates various information, such as setting, operation, abnormality and the like of robot 1.

Though not illustrated in the figures, on a manufacturing line in a factory, a plurality of the spot welding systems described above are provided and a line control panel 6 is connected to each robot controller 3 of these systems. The signals from each robot controller 3 and their respective peripheral devices are sent to line control panel 6 and, based on these signals, line control panel 6 can manage the spot welding manufacturing line in a unified way. Through display section 61 provided in line control panel 6 or a display device (not illustrated) connected to line control panel 6, the operating conditions of each robot 1 can be grasped.

Line control panel 6 receives the signals from each robot controller 3 and outputs external signals to each robot controller 3. Line control panel 6 may output an activation command for executing the working programs to each robot controller 3. The external signals from line control panel 6 may be output via various communication means such as Ethernet® communication. These commands may be issued by operation of teaching control panel 5.

FIG. 2 is a diagram illustrating operations of electrodes 21 and 22 by executing these working programs during the automatic operation. In FIG. 2, while workpiece W is held horizontally, electrodes 21 and 22 are moved to carry out the spot welding. More specifically, a pair of electrodes 21 and 22 are disposed above and below workpiece W, respectively, and vertically with respect to workpiece W and, then, electrodes 21 and 22 are moved to the welding point positions above and below the workpiece to carry out the spot welding.

f the welding point position on one of top and bottom surfaces of the workpiece is changed by the thickness of workpiece W, it overlaps the welding point position on the top and bottom surface of the workpiece. Consequently, in the programs, only either one of the top and bottom surfaces (for example, the bottom surface) of the workpiece is set along with the thickness of the workpiece.

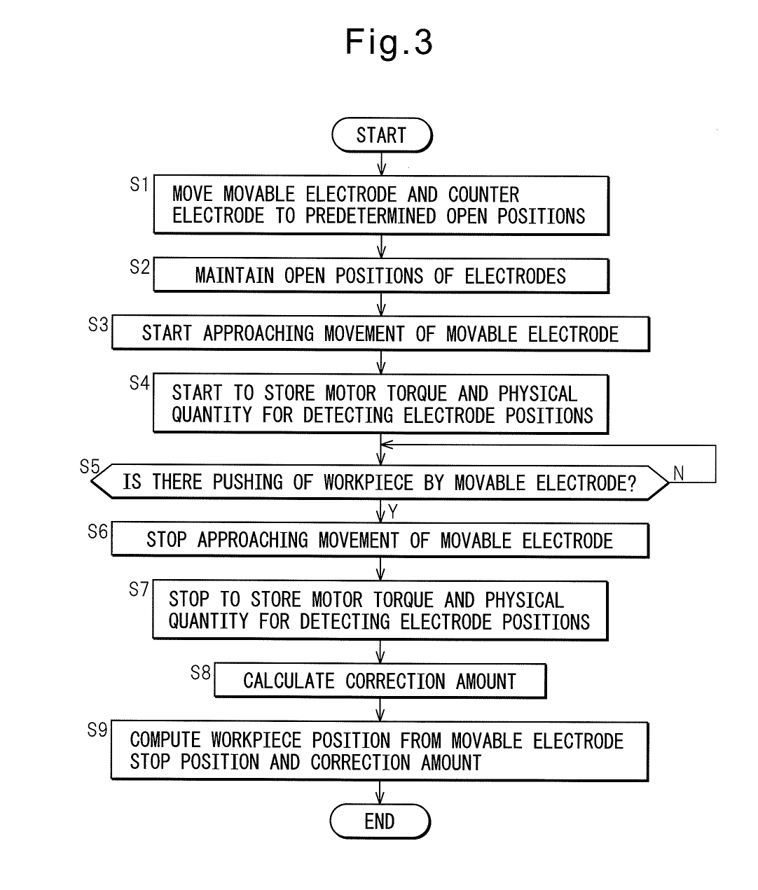

During the automatic operation, first, electrodes 21 and 22 move to waiting positions before starting the spot welding. Thus, electrodes 21 and 22 move to positions 1 that are separated from the respective workpiece surfaces by predetermined distances Da and Db, respectively, at a predetermined velocity and temporarily stop there. Next, electrodes 21 and 22 move to the welding point positions (positions 2) along routes illustrated in the figure at a predetermined velocity and, then, apply a predetermined pressing force to workpiece W. In this state, electrodes 21 and 22 are energized at a predetermined current condition. After that, electrodes 21 and 22 move to waiting positions after completing the spot welding. Thus, electrodes 21 and 22 move to positions 3 in FIG. 3 that are separated from the respective workpiece surfaces by predetermined distances Dc and Dd, respectively, at a predetermined velocity and temporarily stop there.

When there are a plurality of welding points, electrodes 21 and 22 move to waiting positions before starting the spot welding corresponding to the subsequent welding spots so that workpiece W is spot-welded successively at the plurality of welding points. In this case, in consideration of surrounding obstacles 25 at each welding point, the distances Da to Dd from the respective workpiece surfaces to electrodes 21 and 22 are set with respect to each welding point, so that electrodes 21 and 22 do not interfere with obstacles 25.

Even when electrodes 21 and 22 are moved to predetermined welding point positions to spot-weld workpiece W of the same type, due to the fact that workpiece W of a different lot is used or the position of the jig for mounting workpiece W is adjusted, the spot welding point positions on the workpiece surfaces may deviate from the target spot welding point positions. Such deviation results in problems such as overload on workpiece W, incorrect flow of welding current and the like and, as a result, welding quality is degraded. Thus, the spot welding point positions have to be corrected by detecting the actual workpiece position. However, it is too time and labor consuming to manually carry out the correction for all of a plurality of spot welding point positions. On the other hand, the operator may directly check and correct the deviation of the spot welding point positions by visual inspection. However, in this case, the degree of the correction is affected by the skill of the operator and the welding quality cannot be maintained uniformly. Consequently, in this embodiment, before carrying out the spot welding by the automatic operation, the workpiece position is automatically detected and the spot welding point positions on the operation programs are corrected as follows.

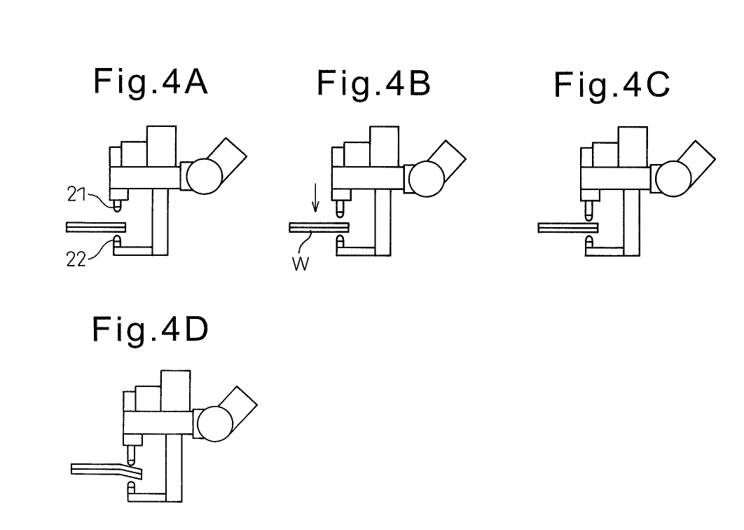

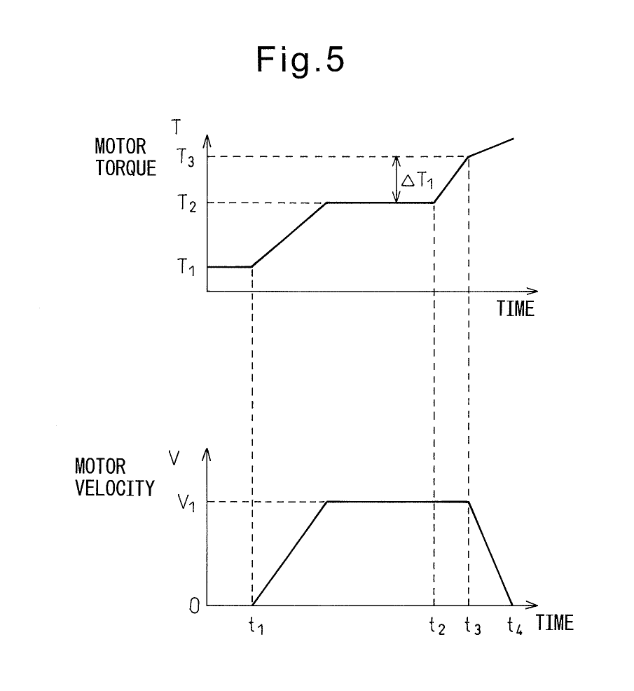

FIG. 3 is a flowchart illustrating an example of a workpiece position detection process carried out in robot controller 3 and welding gun controller 4. FIGS. 4A to 4D are diagrams illustrating an example of operations of electrodes 21 and 22 when the workpiece position detection process is carried out. FIG. 5 is a diagram illustrating an example of variation over time of motor torque T and motor velocity v of servo motor 24 when the workpiece position detection process is carried out.

The motor torque T correlates with a driving current of servo motor 24. Consequently, the motor torque T of FIG. 5 can be determined based on the driving current output from welding gun controller 4. On the other hand, the motor velocity v correlates with a rotation velocity of servo motor 24. Consequently, the motor velocity v of FIG. 5 can be determined based on the rotation angle fed back from encoder 24a.

The workpiece position detection process illustrated in FIG. 3 is started when a workpiece position detection command is input in response to operation of teaching control panel 5 or line control panel 6 by the operator. This workpiece position detection process is carried out after the working programs are configured. Consequently, in the memory, the spot welding point position on the bottom surface of the workpiece, the workpiece thickness t0, the waiting positions before and after starting the spot welding (Da, Db, Dc and Dd in FIG. 2), the motor velocity v1 when electrodes 21 and 22 are moved to the spot welding point positions and the like are stored in the working programs as initial set values.

In step S1 in FIG. 3, control signals are output to servo motors 13 and 24 to move electrodes 21 and 22 of spot welding gun 2 to predetermined open positions vertically above and vertically below the welding point positions of workpiece W. This process is carried out by using the working programs to move electrodes 21 and 22 to the open positions (indicated by dotted lines at the position 2) separated from the respective workpiece surfaces by Da and Db, respectively, along routes illustrated in FIG. 2. Because the working programs are created in consideration of the positions of obstacles 25 during the spot welding, the interference of electrodes 21 and 22 with workpiece W and obstacles 25 can be prevented by using the working programs.

In step S2, control signals are output to servo motors 13 and 24 to maintain electrodes 21 and 22 to at the open positions in step S1. As a result, as illustrated in FIG. 4A, electrodes 21 and 22 come to rest at the respective positions separated from the workpiece surface by the predetermined distances Da and Db, respectively. At this time, as illustrated in FIG. 5, the motor torque T is constant (T1) and the motor velocity v is 0. This state is allowed to continue until a predetermined time t1. The movement of electrodes 21 and 22 to the open positions above and below the workpiece as well as the stoppage of the electrodes may be carried out not automatically but manually by the operator who visually checks the positions of electrodes 21 and 22. In other words, the process in steps S1 and S2 may be omitted.

In step S3, a control signal is output to servo motor 24 to allow movable electrode 21 to approach the workpiece surface as illustrated in FIG. 4B. For example, as illustrated in FIG. 5, the velocity of servo motor 24 is controlled so that the motor velocity v is accelerated to a predetermined velocity v1 and, after that, the predetermined velocity v1 is maintained (the time t1 to the time t2). At this time, as illustrated in FIG. 5, the motor torque T increases from T1 to T2 and, after that, becomes constant when movable electrode 21 moves at a constant velocity. Hereinafter, the state in which the motor torque T is substantially constant during the time period between the times t1 and t2 is referred to as a reference state, and the motor torque T2 in the reference state is referred to as a reference torque. When the distance between movable electrode 21 and the workpiece surface is small before the approaching movement, in step S3, movable electrode 21 may be allowed to move in a direction opposite to workpiece W once and, then, move to approach the workpiece surface, so that movable electrode 21 can be allowed to approach the workpiece surface at a constant velocity and, as a result, the reference state can be secured.

In step S4, storage of a physical quantity for detecting the motor torque T and a physical quantity for detecting the positions of electrodes 21 and 22 in the memory is started. Thus, the driving current output to servo motor 24 and the signals from encoders 13a and 24a are stored in the memory every predetermined time period (for example, every few msec).

In step S5, it is determined whether there is pushing of workpiece W by movable electrode 21 or not. The pushing of workpiece W means that, after movable electrode 21 comes into contact with the workpiece surface as illustrated in FIG. 4C, movable electrode 21 is further pushed sufficiently to bend workpiece W as illustrated in FIG. 4D. After this pushing of workpiece W, if movable electrode 21 is moved upward to stop the pushing of workpiece W, workpiece W returns to the state before the pushing. In step S5, the motor torque T is computed based on the driving current output to servo motor 24 and the motor torque T when the motor velocity v is constant (the reference state) is set as the reference torque T2. Then, when the motor torque T increases from this reference torque T2 to a predetermined amount ΔT1 or more, it is determined that there is the pushing of workpiece W.

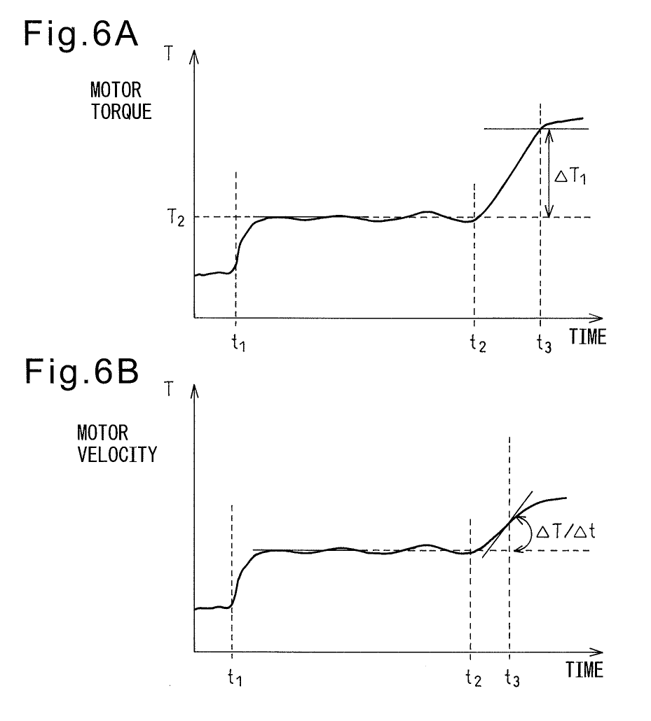

The motor torque T in the reference state is not strictly constant but it varies within a predetermined range ΔT0 (see FIG. 6A.) Consequently, in step S5, the maximum value of the motor torque T in the reference state may be set as the reference torque T2 or, alternatively, an average value or a minimum value of the motor torque T in the reference state may be set as the reference torque T2. In consideration of the variation of the motor torque T in the reference state, the predetermined amount ΔT1 is set to a value that is at least larger than ΔT0 and at which workpiece W is not plastically deformed. ΔT0 and ΔT1 can be experimentally determined and the experimentally determined values are stored in advance as preset values.

At this time, as illustrated in FIG. 5, when movable electrode 21 starts to make contact with the workpiece surface at the time t2, a load applied to servo motor 24 increases, and thus, the motor torque T increase. When the increment ΔT of the motor torque T reaches the predetermined amount ΔT1 at the time t3, controllers 3 and 4 determine that there is the pushing of workpiece W. This motor torque T at the time t3 is referred to as a pushing motor torque T3. If it is determined that there is the pushing of workpiece W in step S5, the operation proceeds to step S6.

In step S6, a control signal is output to servo motor 24 to stop the approaching movement of movable electrode 21. As a result, as illustrated in FIG. 5, the motor velocity v is reduced and it reaches 0 at the time t4. During this reducing speed and stoppage, as illustrated in FIG. 5, the motor torque T exceeds the pushing motor torque T3. In step S7, the storing operation (step S4) for the physical quantity for detecting the motor torque T (the driving current for servo motor 24) and the physical quantity for detecting the positions of electrodes 21 and 22 (the signals from encoders 13a and 24a) terminates.

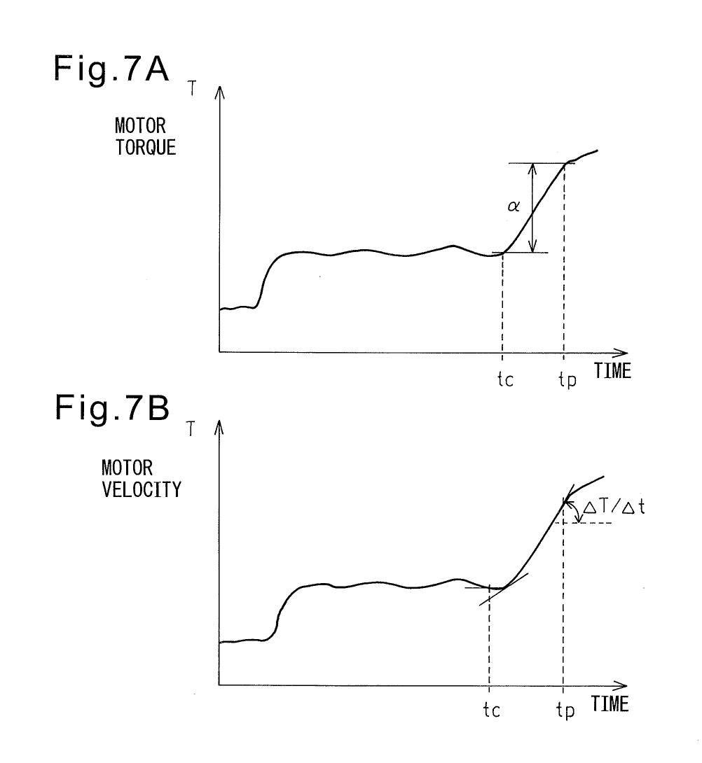

In step S8, a position detection correction amount Δd of movable electrode 21 or, in other words, the pushing amount of workpiece W by movable electrode 21 is calculated. In order to calculate the correction amount Δd, first, based on the time-series data of motor torque T stored in the memory, the contact start time when movable electrode 21 comes into contact with the workpiece surface (t2 in FIG. 5) is calculated. More specifically, going back from the pushing time t3 of workpiece W, the time tc when the motor torque T becomes less than the pushing motor torque T3 by a predetermined amount α (see FIG. 7A) is calculated as the contact start time. Next, based on the signals from encoders 13a and 24a stored in the memory, the movable electrode position at the contact start time and the movable electrode position at a stop time of the approaching movement of movable electrode 21 are calculated, respectively, and a difference between them is set as the correction amount Δd.

The predetermined amount a may be experimentally determined in advance. Alternatively, it may be determined based on the pushing motor torque T3 at the pushing time t3 during the movement of movable electrode 21 and the reference torque T2 in the reference state. For example, a difference (the predetermined amount ΔT1) between the pushing motor torque T3 and the reference torque T2 may be determined as the predetermined amount α. Alternatively, a value calculated by multiplying ΔT1 by a predetermined rate (for example, 0.5) may be determined as the predetermined amount α.

In this case, the movable electrode position when the pushing of workpiece W is determined (t3 in FIG. 5) differs from the movable electrode position (a movable electrode stop position) when movable electrode 21 stops the approaching movement (t4 in FIG. 5) by a distance in which movable electrode 21 reduces speed and stops. Consequently, in step S8, it is preferable to calculate the movable electrode position at the contact start time and the movable electrode stop position, respectively, and set the difference between them as the correction amount Δd. In this way, by taking the reducing speed and stoppage of movable electrode 21 into consideration, calculation accuracy of the correction amount Δd is improved. Since movable electrode 21 reduces speed and stops in a short time, there is substantially no problem with regard to the movable electrode position when the pushing of workpiece W is determined or, in other words, the movable electrode position at the time t3 as the movable electrode stop position to calculate the correction amount Δd.

In step S9, the workpiece position is calculated by using the movable electrode stop position and the correction amount Δd. More specifically, a value determined by deviating the movable electrode stop position upward by the correction amount Δd or, in other words, the movable electrode position in the state in which movable electrode 21 starts to make contact with the workpiece surface is calculated and stored in the memory as the spot welding point position on the top surface of the workpiece. Further, a value determined by deviating the spot welding point position on the top surface of the workpiece by the thickness t0 of workpiece W is calculated and stored in the memory as the spot welding point position on the bottom surface of the workpiece. These calculated spot welding point positions are used to correct the working programs. The movable electrode stop position in step S9 may be the movable electrode position when the pushing of workpiece W is determined.

A difference between the spot welding point positions detected by the process described above and the spot welding point positions set in advance in the working programs may be calculated and the difference may be indicated on display section 52 of teaching control panel 5, display section 61 of line control panel 6 and the like. Further, when the difference is equal to or more than a predetermined value, the operator may be notified of an alarm and the like via teaching control panel 5 or line control panel 6.

After that, the workpiece position detection process at the predetermined welding point positions is terminated. When the workpiece position detection process is terminated, in response to the signals from controllers 3 and 4, electrodes 21 and 22 move to the positions separated from the workpiece surface by the predetermined amounts Dc and Dd, respectively. When there are a plurality of welding points, electrodes 21 and 22 move to the next welding points and a similar process is carried out. Electrodes 21 and 22 may be moved manually by the operator in the workpiece position detection process.

The operation of this embodiment can be summarized as follows. When the workpiece position detection command is input by the operation of the operator, movable electrode 21 and counter electrode 22 move to the open positions separated from the workpiece surface by the predetermined amounts Da and Db, respectively (step S1). After that, movable electrode 21 approaches workpiece W at the predetermined velocity v1 (step S3). FIG. 6A is a diagram illustrating the variation of the motor torque T at this time. Based on the detection result of the motor torque T during the approaching movement of movable electrode 21, the substantially constant value of the motor torque T is set as the reference torque T2. When the motor torque T becomes larger than the reference torque T2 by the predetermined value ΔT1 or more, movable electrode 21 stops the approaching movement (step S5 and step S6).

Based on the time-series data of the motor torque T obtained as a result of the approaching movement of movable electrode 21 described above, the time when movable electrode 21 has started to make contact with the workpiece surface is calculated (step S8). More specifically, as illustrated in FIG. 7A, going back from the time tp when movable electrode 21 pushes workpiece W (t3 in FIG. 6A), the time tc when the motor torque T decreases by the predetermined amount α is calculated as the contact start time. Further, the difference between the movable electrode position at the contact start time and the movable electrode position at the stop time of movable electrode 21 is computed and the position detection correction amount Δd corresponding to the pushing amount of movable electrode 21 is set (step S8). Then, based on the stop position of movable electrode 21 and the position detection correction amount Δd, the spot welding point position on the workpiece surface is computed (step S9).

This embodiment can exhibit the following effects.

(1) Based on the time-series data of the motor torque T when movable electrode 21 is approached the workpiece surface, the time when movable electrode 21 starts to make contact with the workpiece surface is calculated and the position detection correction amount Δd corresponding to the pushing amount of movable electrode 21 on the workpiece surface is also calculated. Then, based on the stop position of movable electrode 21 after movable electrode 21 is pushed and the position detection correction amount Δd, the workpiece position is calculated. As a result, the workpiece position (workpiece surface position) can be detected in consideration of the pushing amount by movable electrode 21 from movable electrode 21 starts to make contact with the workpiece surface till it stops. Consequently, the detection accuracy of the workpiece position is improved.

(2) Based on the motor torque T, it is determined whether movable electrode 21 is in the predetermined pushing state or not. If it is determined that movable electrode 21 is in the predetermined pushing state, the approaching movement of movable electrode 21 is stopped. As a result, movable electrode 21 can be reliably pushed on the workpiece surface within a range of the elastic deformation of workpiece W. Consequently, the workpiece position can be accurately detected based on the pushing amount by movable electrode 21.

(3) The state in which the motor torque T is constant during the approaching movement of movable electrode 21 is defined as the reference state and, when the motor torque T becomes larger than the reference torque T2 by the predetermined value ΔT1 or more, the approaching movement of movable electrode 21 is stopped. As a result, excessive pushing of movable electrode 21 can be prevented and, thus, workpiece W can be prevented from being damaged.

(4) Movable electrode 21 is allowed to approach the workpiece surface at the predetermined velocity v1 and the motor torque T in this constant velocity movement is defined as the reference torque T2. As a result, the reference torque T2 can be properly set and the predetermined pushing by movable electrode 21 can be accurately judged.

(5) Returning to the time when workpiece W is pushed, the time when the motor torque T decreases by the predetermined amount α is calculated as the contact start time. As a result, even when the motor torque T gradually changes after movable electrode 21 makes contact with the workpiece surface, the contact start time can be accurately determined and, consequently, the detection accuracy of the workpiece position is improved.

(6) The workpiece position detection process is carried out by using the working programs for the spot welding. As a result, electrodes 21 and 22 can be moved to a predetermined welding position to detect the workpiece position without interfering with obstacles 25 and the like.

In the process in controllers 3 and 4 described above (step S5), it is determined that the predetermined pushing state is reached when the motor torque T becomes larger than the reference torque T2 by the predetermined value ΔT1 or more (FIG. 6A). However, the process as a determination section is not limited to that described above. For example, as illustrated in FIG. 6B, when an increasing rate ΔT/Δt of the motor torque T per unit time becomes equal to or larger than an increasing rate ΔT0/Δt of the motor torque T per unit time in the reference state by a predetermined amount or more, it may be determined that the predetermined pushing state is reached. Alternatively, on the assumption that the increasing rate ΔT0/Δt of the motor torque T in the reference state is substantially zero, when the increasing rate ΔT/Δt of the motor torque T per unit time becomes equal to or larger than a predetermined value, it may be determined that the predetermined pushing state is reached.

The motor torque T2 in the reference state may be experimentally determined in advance. When the reference torque T2 is known, in consideration of the reference torque T2, a motor torque Ta or an increasing rate ΔTa/Δt of the motor torque T per unit time that is a threshold for determining the pushing state may be set in advance. Then, when the motor torque T becomes equal to or larger than the predetermined value Ta or when the increasing rate ΔT/Δt of the motor torque T becomes equal to or larger than the predetermined value ΔTa/Δt, it may be determined that the predetermined pushing state is reached. Alternatively, not in consideration of the reference state at all, when the motor torque T becomes equal to or larger than a predetermined value or when the increasing rate ΔT/Δt of the motor torque T becomes equal to or larger than a predetermined value, it may be simply determined that the predetermined pushing state is reached.

In the embodiment described above, in the process in controllers 3 and 4 (step S8), going back from the pushing time tp of workpiece W, the time tc when the motor torque T decreases by the predetermined amount α is calculated as the contact start time (FIG. 7A). However, the calculation process of the contact start time is not limited as described above and the contact start time may be calculated by paying attention to the variation of the increasing rate ΔT/Δt of the motor torque T per unit time. For example, as illustrated in FIG. 7B, the increasing rate ΔT/Δt of the motor torque T is a positive value. Consequently, going back from the pushing time tp, the time tc when ΔT/Δt transitions from the positive value to zero or a negative value may be calculated as the contact start time.

In the embodiment described above, a series of operations for detecting the workpiece position are carried out automatically by controllers 3 and 4. However, a portion of them may be carried out manually. The approaching and stop operations of movable electrode 21 are carried out automatically in response to the signals from controllers 3 and 4 (step S3 and step S6). However, for example, at least any one of the approaching and stop operations may be carried out manually by the operator manipulating a switch device and the like while monitoring the variation of motor torque T. The operator may monitor the pushing state of movable electrode 21 and determine whether movable electrode 21 is in the predetermined pushing state after making contact with the workpiece surface or not. Consequently, controllers 3 and 4 may not be configured as a control section for controlling servo motors 13 and 24 or as a determination section for determining whether the predetermined pushing state is reached or not.

In the embodiment described above, the correction amount Δd is calculated from the difference between the movable electrode position at the contact start time and the movable electrode position at the approaching movement stop time to detect the workpiece position. However, the correction amount Δd may not be calculated and, for example, the workpiece position may be detected by using the correction amount Δd determined experimentally in advance. Alternatively, a bending amount of workpiece W when movable electrode 21 stops may be measured visually or by using various measuring instruments to determine the correction amount Δd. Further alternatively, an operation in which movable electrode 21 is moved toward the workpiece surface by a predetermined distance and stopped and, at this time, the contact state of movable electrode 21 with the workpiece surface is checked may be repeated and the correction amount Δd may be determined from the moving distance of movable electrode 21 for one movement and the variation of the motor torque T at that time.

In the embodiment described above, the motor torque T is detected based on the driving current output to servo motor 24. However, any physical quantity correlative to the motor torque T, such as the torque, current, velocity, acceleration and the like may be detected and the configuration of a physical quantity detection section is not limited to that described above. The positions of electrodes 21 and 22 are detected based on the signals from encoders 13a and 24a. However, the configuration of a position detection section is not limited as described above. The driving current output to servo motor 24 and the signals from encoders 13a and 24a are stored in the memory of controllers 3 and 4. However, the configuration of a storage section is not limited as described above. The driving current and the signals may be stored in an external storage device.

In the embodiment described above, movable electrode 21 is allowed to approach the workpiece surface. However, in place of movable electrode 21, counter electrode 22 may be allowed to approach the workpiece surface and, based on the variation of the physical quantity at that time, the contact start time may be calculated. Thus, servo motor 1 may drive robot 1 to allow counter electrode 22 approach and separate from the workpiece surface and the contact start time may be calculated based on the variation of the torque of servo motor 13.

The workpiece position detection process in FIG. 3 is carried out by CPUs of robot controller 3 and welding gun controller 4. However, robot controller 3 and welding gun controller 4 may be integrated into one controller. Thus, robot controller 3 may include functions of welding gun controller 4 and the configuration of a computation section is not limited to that described above. The positions of electrodes 21 and 22 are controlled by using the predetermined working programs for the spot welding. However, the positions of electrodes 21 and 22 may be determined independently of the working programs.

In the embodiment described above, the contact start time is calculated based on the time-series data of the motor torque T and the position detection correction amount Δd is calculated from the difference between the movable electrode position at the contact start time and the movable electrode position when the pushing movement is stopped (step S8). Then, the workpiece position is computed based on the movable electrode stop position and the correction amount Δd (step S9). However, the workpiece position may be computed without calculating the correction amount Δd. For example, the movable electrode position at the contact start time may be determined directly from the detection value of encoder 24a stored in the memory and, based on this movable electrode position, the workpiece position may be computed. In this case, it is not necessary to calculate the correction amount Δd and, as a result, the process in controllers 3 and 4 can be simplified. Thus, the most significant characteristic of the present invention is that the contact start time of movable electrode 21 is calculated based on the time-series data of the motor torque T and the movable electrode position at this contact start time is determined so that the detection accuracy of the workpiece position can be improved. Consequently, it is not always necessary to determine the correction amount Δd. However, if the correction amount Δd at each welding position is determined and stored in the memory, a validity of the workpiece detecting process can be verified based on a comparison of the correction amount Δd with a correction amount determined when the workpiece surface position at the same welding position is detected at another time. Furthermore, based on a comparison of a correction amount determined at a welding position with another correction amount determined at another welding position, a validity of the workpiece detecting process at respective welding position can be verified.

Summarizing the above, so long as the position detection method for the workpiece to be welded for detecting the workpiece surface position according to the present invention includes the step for allowing movable electrode 21 or counter electrode 22 to approach the workpiece surface so that movable electrode 21 or counter electrode 22 abuts against the workpiece surface in the state in which workpiece W is disposed between movable electrode 21 and counter electrode 22; the step for judging the contact start time of movable electrode 21 or counter electrode 22 with the workpiece surface based on the motor torque T when movable electrode 21 or counter electrode 22 approaches the workpiece surface; and the step for computing the workpiece position based on the positions of electrodes 21 and 22 at the time when it is determined that movable electrode 21 or counter electrode 22 starts to make contact with the workpiece surface, this method is not limited to that described above.

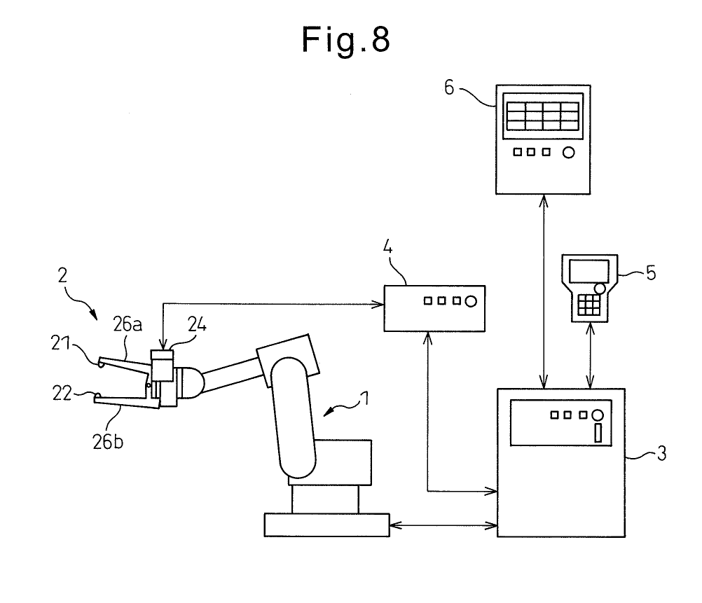

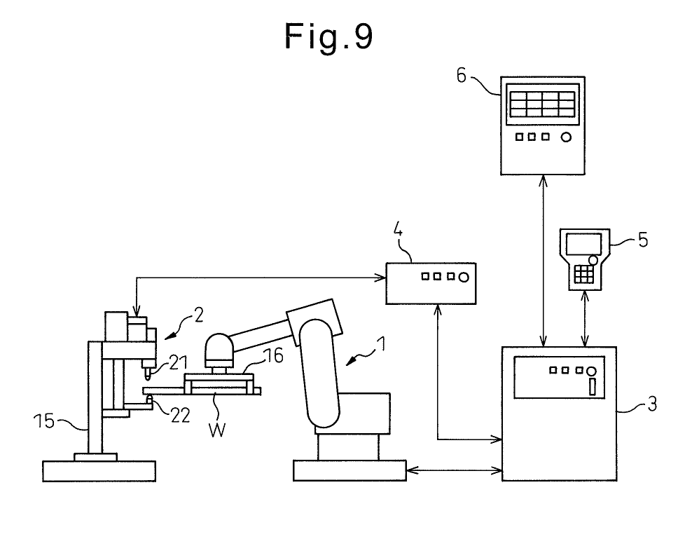

So long as the spot welding system has spot welding gun 2 having a pair of electrodes 21 and 22 that approach and separate from each other by servo motor 24, and robot 1 for movably holding either one of spot welding gun 2 and workpiece W in a manner movable relative to each other so that workpiece W is disposed between electrodes 21 and 22, the overall configuration of the spot welding system having the position detection device for the workpiece to be welded is not limited to that of FIG. 1. For example, both movable electrode 21 and counter electrode 22 may be movable with respect to frame 23a of spot welding gun 2. The spot welding system may be configured as illustrated in FIG. 8 or 9.

FIG. 8 illustrates an example in which spot welding gun 2 is configured as a so-called X-type spot welding gun that has a pair of openable and closeable gun arms 26a and 26b, and movable electrode 21 and counter electrode 22 attached to tips of gun arms 26a and 26b, respectively. FIG. 9 illustrates an example in which spot welding gun 2 is supported by a gun stand 15 disposed at a predetermined position and workpiece W is held by a robot hand 16 at a tip of robot 1, so that workpiece W is moved with respect to spot welding gun 2 and disposed between electrodes 21 and 22 by driving power of robot 1. The gun stand 15 may be configured movable.

According to the present invention, because the workpiece position is computed based on the electrode position when the electrode actually comes into contact with the workpiece, the workpiece position can be accurately detected.

While the present invention has been described with reference to specific preferred embodiments, it will be understood, by those skilled in the art, that various changes or modifications may be made thereto without departing from the scope of the following claims.

1. A position detection device for a workpiece to be welded comprising:
a spot welding gun having a pair of electrodes adapted to be disposed opposite each other across the workpiece;
a robot for holding either one of the spot welding gun and the workpiece in a manner movable relative to each other;
a servo motor for allowing the pair of electrodes to approach the workpiece and separate from the workpiece;
a physical quantity detection section for detecting a physical quantity correlative to a torque of the servo motor when the servo motor allows one of the pair of electrodes to approach a surface of the workpiece so that the one of the pair of electrodes abuts against the surface of the workpiece;
a position detection section for detecting positions of the pair of electrodes;
a storage section for storing the physical quantity detected by the physical quantity detection section and a value detected by the position detection section; and
a computation section for calculating a contact start time at which the one of the pair of electrodes comes into contact with the surface of the workpiece based on time-series data of the physical quantity stored in the storage section, and computing a position of the workpiece at the contact start time based on the value detected by the position detection section stored in the storage section.

2. A position detection device for a workpiece to be welded according to claim 1,
further comprising a control section for controlling the servo motor,
wherein the computation section has a determination section for determining whether the one of the pair of electrodes is in a predetermined pushing state after the one of the pair of electrodes makes contact with the surface of the workpiece or not, based on the physical quantity detected by the physical quantity detection section, and
wherein the control section controls the servo motor to stop approaching the one of the pair of electrodes toward the surface of the workpiece when the determination section determines that the one of the pair of electrodes is in the predetermined pushing state.

3. A position detection device for a workpiece to be welded according to claim 2, wherein the determination section determines that the one of the pair of electrodes is in the predetermined pushing state when the physical quantity detected by the physical quantity detection section becomes equal to or larger than a predetermined value, or when an increasing rate of the physical quantity detected by the physical quantity detection section per unit time becomes equal to or larger than a predetermined value.

4. A position detection device for a workpiece to be welded according to claim 2, wherein the determination section determines that the one of the pair of electrodes is in the predetermined pushing state when the physical quantity detected by the physical quantity detection section becomes larger than a physical quantity in a reference state by a predetermined amount or more, the reference state being a state in which the physical quantity is substantially constant before the one of the electrodes makes contact with the surface of the workpiece, or when an increasing rate of the physical quantity detected by the physical quantity detection section per unit time becomes larger than an increasing rate of the physical quantity per unit time in the reference state by a predetermined amount or more.

5. A position detection device for a workpiece to be welded according to claim 4, wherein the reference state is a state in which the one of the pair of electrodes approaches the surface of the workpiece at a constant velocity.

6. A position detection device for a workpiece to be welded according to claim 2, wherein the computation section calculates, as the contact start time, a second time at which the physical quantity stored in the storage section becomes less than the physical quantity at a first time by a predetermined amount or more, going back from the first time at which the determination section determines that the one of the pair of electrodes is in the predetermined pushing state.

7. A position detection device for a workpiece to be welded according to claim 2, wherein the computation section calculates, as the contact start time, a second time at which an increasing rate of the physical quantity stored in the storage section per unit time becomes 0 or a negative value, going back from a first time at which the determination section determines that the one of the pair of electrodes is in the predetermined pushing state.

8. A position detection device for a workpiece to be welded according to claim 2, wherein the control section controls the servo motor based on a predetermined working program for carrying out spot welding.

9. A position detection device for a workpiece to be welded according to claim 2, wherein the computation section calculates a position detection correction amount of the one of the pair of electrodes, based on the value detected by the position detection section at the contact start time, stored in the storage section, and the value detected by the position detection section when the control section stops the one of the pair of electrodes, stored in the storage section, and computes the position of the workpiece based on the position detection correction amount and the value detected by the position detection section when the one of the pair of electrodes is stopped.

10. A position detection method for a workpiece to be welded for detecting a position of the workpiece includes the steps of:
holding, by a robot, either one of a spot welding gun and the workpiece in a manner movable relative to each other, the spot welding gun having a pair of electrodes adapted to be disposed oppositely to each other across the workpiece;
allowing, by a servo motor, one of the pair of electrodes to approach a surface of the workpiece so that the one of the pair of electrodes abuts against the surface of the workpiece;
judging a contact start time at which the one of the pair of electrodes comes into contact with the surface of the workpiece, based on a physical quantity correlative to a torque of the servo motor when the one of the pair of electrodes approaches the surface of the workpiece; and
computing a position of the workpiece based on positions of the pair of electrodes at the contact start time.
